(19) United States
(12) Patent Application Publication
(10) Pub. No.: US 2020/0011476 A1
(43) Pub. Date: Jan. 9, 2020

(54) Refrigerator and Support Device for Refrigerator

(71) Applicant: Daewoo Electronics Corporation, Gwangju (KR)

(72) Inventor: Dong Sun KIM, Seongnam-si (KR)

(21) Appl. No.: 16/450,210

(22) Filed: Jun. 24, 2019

(30) Foreign Application Priority Data
Jul. 3, 2018 (KR) 10-2018-0077356

(51) Int. Cl. F16M 11/20; F25D 23/00; F25D 19/00

(52) U.S. Cl. CPC F16M 11/2014; F25D 19/00; F25D 23/00

(57) ABSTRACT

A refrigerator includes a main body having one or more storage spaces and a support device configured to rotatably support the main body. The main body includes one or more storage spaces, a front face, and one or more doors configured to open and close at least one of the storage space(s). The support device includes a support body; a rotatable, upwardly extending shaft at or in a center of the support body and in a coupling hole, cavity or opening in the main body; a plurality of balls on and/or in the support body, configured to support the main body; and a coupling pin configured to move in a vertical direction and to fix a direction of the front face of the main body. The main body includes a plurality of latching holes, cavities or openings outside the coupling hole, cavity or opening, configured to receive the coupling pin such that the coupling pin limits rotation of the main body when the coupling pin is in one of the latching holes, cavities or openings.

### TECHNICAL FIELD

The disclosure relates to a refrigerator and a support device for the refrigerator.

### BACKGROUND

A refrigerator may be a device intended for storing food at a low temperature, and may be configured to freeze or refrigerate the food, depending to type of the food to be stored and the length of time of the storage. To this end, the refrigerator may include a cool air supply device that implements a cooling cycle. The cool air supply device is configured such that a refrigerant undergoes the process of compression—condensation—expansion—evaporation to generate cool air as the refrigerant circulates in the cooling cycle. The cool air generated by an evaporator of the cool air supply device is supplied to the storage space of the refrigerator, and the cool air supplied to the storage space of the refrigerator is circulated by convection so that the food in the refrigerator may be stored at a predetermined temperature. Generally, a main body of the refrigerator has a rectangular or parallelepiped shape, in which a front face thereof is open. The inner part of the main body includes a refrigerating chamber and a freezing chamber. The front face of the main body includes a refrigerating chamber door and a freezing chamber door for selectively shielding the openings in the main body.

Such a refrigerator may be classified depending on the positions of the freezing chamber and the refrigerating chamber, and types of refrigerators may include a top-mount type, in which the freezing chamber is above the refrigerating chamber, a bottom-freezer type, in which the freezing chamber is below the refrigerating chamber, and a side-by-side type, in which the freezing chamber and the refrigerating chamber are side by side.

A refrigerator is a relatively heavy and bulky electronic device. Thus, it may be difficult to change the direction or position of the refrigerator after the refrigerator is installed.

### SUMMARY

Embodiments of the disclosure solve the above problem(s) and provide a refrigerator and a support device for the refrigerator that enable changing the direction in which the front of the refrigerator faces.

In accordance with an aspect of the present invention, there is provided a refrigerator comprising a main body having a front face, one or more storage spaces, and a bottom surface with a coupling hole, cavity or opening therein; a support device configured to rotatably support the main body, and one or more doors configured to open and close at least one of the one or more storage spaces, wherein the support device includes a support body, which may have a plate shape or a substantially flat or planar uppermost surface; a rotatable, upwardly extending shaft at or in a center of the uppermost surface of the support body and in a coupling hole, cavity or opening in the main body; a plurality of balls on and/or in the support body, configured to support the main body; and a coupling pin configured to move in a vertical direction and to fix a direction of the front face of the main body; the main body includes; a plurality of latching holes, cavities or openings outside the coupling hole, cavity or opening, configured to receive the coupling pin such that the coupling pin limits rotation of the main body when the coupling pin is in one of the plurality of the latching holes, cavities or openings.

The support device may include a mounting hole, cavity or opening containing the coupling pin, and the mounting hole, cavity or opening may include an elastic member (e.g., a spring) configured to elastically support the coupling pin and enable the coupling pin to move in a vertical direction.

The coupling pin may include a head supported by the elastic member and configured to move from and/or in the mounting hole, cavity or opening in the vertical direction; and an extension extending upward from the head and having a diameter smaller than that of the head and a rounded upper surface or tip. The latching holes, cavities or openings may have a shape corresponding or complementary to the upper surface or tip of the extension, and the upper surface or tip of the extension may be configured to slide along a surface of the latching holes, cavities or openings (e.g., when a force is applied from the user to rotate the main body so that the coupling pin can come out of the latching hole, cavity or opening).

The support body may include a first body having a first hole, cavity or opening with a size corresponding to the head; and a second body having a second hole, cavity or opening with a size corresponding to the extension. The ball may be between or in the first body and the second body, and a part or portion of the ball may be exposed by the second body and may be configured to touch or contact the main body.

The first body may have a cavity or socket with a spherical (e.g., hemispherical or other truncated sphere) shape, the ball may fit or sit in the spherical cavity or socket, the second body may have a third hole, cavity or opening (e.g., in the shape of a spherical segment) configured to expose a part or surface of the ball and/or to cover part of the ball, and the ball may be configured to roll or rotate in a space (e.g., the cavity or socket and the third hole, cavity or opening) in the first body and the second body.

The head and the elastic member may be in a hole, cavity or opening in the first body, and the extension penetrates through a corresponding hole, cavity or opening (e.g., the second hole, cavity or opening) in the second body. The head may be prevented from leaving the first body (e.g., the head may have dimensions greater than those of the second hole, cavity or opening in the second body).

The refrigerator may include a plurality of the coupling pins and a plurality of the mounting holes, cavities or openings.

The refrigerator may further include a bearing in the coupling hole, cavity or opening, coupled to the rotatable shaft. An end of the rotatable shaft may be spaced apart from a deepest surface of the coupling hole, cavity or opening.

In accordance with another aspect of the present invention, there is provided a support device configured to support a main body of a refrigerator (e.g., which may have an open front face that is opened and closed with one or more doors), comprising a support body; a rotatable shaft on or in a center of an upper surface of the support body; a ball on and/or in the support body, a surface of which is configured to touch or contact the main body; and a coupling pin configured to be selectively coupled to the main body, wherein the support body includes a plurality of ball cavities or sockets spaced apart from the rotatable shaft by a predetermined interval, a mounting hole, cavity or opening that includes the coupling pin at a position not overlapping the rotatable shaft and the ball cavities or sockets. The coupling pin is configured to move up and down in the mounting hole, cavity or opening, and as the main body rotates, the coupling pin is configured to catch in one of a plurality of latching holes, cavities or openings on or in a bottom surface of the main body.

The support body may further include a first body configured to contact the ground (e.g., a floor or other relatively large, supported flat surface); and a second body on the first body, wherein the coupling pin includes an extension having a rounded shape or end, configured to enter the latching holes, cavities or openings; and a head on one side (e.g., an opposite end) of the extension and in the first body or between the first body and the second body. The head may be in the mounting hole, cavity or opening. The support body may further comprise an elastic member in the mounting hole, cavity or opening, configured to elastically support the head.

When the main body rotates in one direction or the other (e.g., with respect to the rotatable shaft), the elastic member may be compressed, and the coupling pin may move into the mounting groove hole, cavity or opening. When the coupling pin moves to an inner side overlaps one of the latching groove holes, cavities or openings, the coupling pin may moves into one of the latching holes, cavities or openings, the elastic member may be tensioned (e.g., apply or transfer an elastic force to the head), and the coupling pin may move upward.

In accordance with yet another aspect of the present invention, a refrigerator may comprise a main body having one or more storage spaces; and a support device configured to rotatably support the main body, wherein the main body includes one or more storage spaces having an open front face, one or more doors configured to open and close at least one of the one or more storage spaces, and a control unit configured to control the support device, the support device includes a support body placed on a bottom surface of an installation space; a rotatable, upwardly extending shaft at or in a center of the support body and in a lower part or portion of the main body; a plurality of balls on or in the support body, configured to support the main body and/or enable the main body to rotate about the rotatable shaft; and a fixing member capable of moving up and down in accordance with a signal from the control unit; the main body includes a plurality of latching holes, cavities or openings corresponding to the fixing member in the lower part or portion (e.g., a lowermost surface) thereof and a coupling hole, cavity or opening configured to receive the rotatable shaft, and the fixing member moves up and down according to the signal from the control unit. When the fixing member moves up or down, it is respectively coupled to or released from one of the latching holes, cavities or openings.

In a refrigerator and a support device for the refrigerator according to the embodiments of the disclosure, there is an advantage in which a direction of a front face of the refrigerator may be changed.

### BRIEF DESCRIPTION OF THE DRAWINGS

FIG. 1 is a perspective view showing a configuration of a refrigerator according to one or more embodiments of the disclosure;

FIG. 2 is a cross-sectional view schematically showing an embodiment of the refrigerator of FIG. 1;

FIG. 3 is a perspective view showing a support device suitable for the refrigerator of FIG. 1;

FIG. 4 is a bottom view of the main body of the refrigerator of FIG. 1;

FIG. 5 is a perspective view showing a state in which an angle between the main body and the support device of the refrigerator of FIG. 1 is changed; and

FIG. 6 is a cross-sectional view schematically showing a configuration of a refrigerator according to another embodiment of the disclosure.

### DETAILED DESCRIPTION

Hereinafter, specific embodiments of the disclosure will be described in detail with reference to the drawings.

Further, in the following description of the disclosure, detailed descriptions of known functions and configurations incorporated herein will be omitted when such descriptions may make the subject matter of the disclosure unclear.

Further, in the following description, it may be understood that the “front” or a “front direction” may be the direction toward a front face or side of the refrigerator (e.g., towards the outer surface of the door[s]), the “rear” or a “rear direction” may be the direction toward a rear face or side of the refrigerator (e.g., towards the side or surface of the refrigerator opposite from the outer surface of the door[s]), and a “left direction” and a “right direction” may be one side direction and the other side direction.

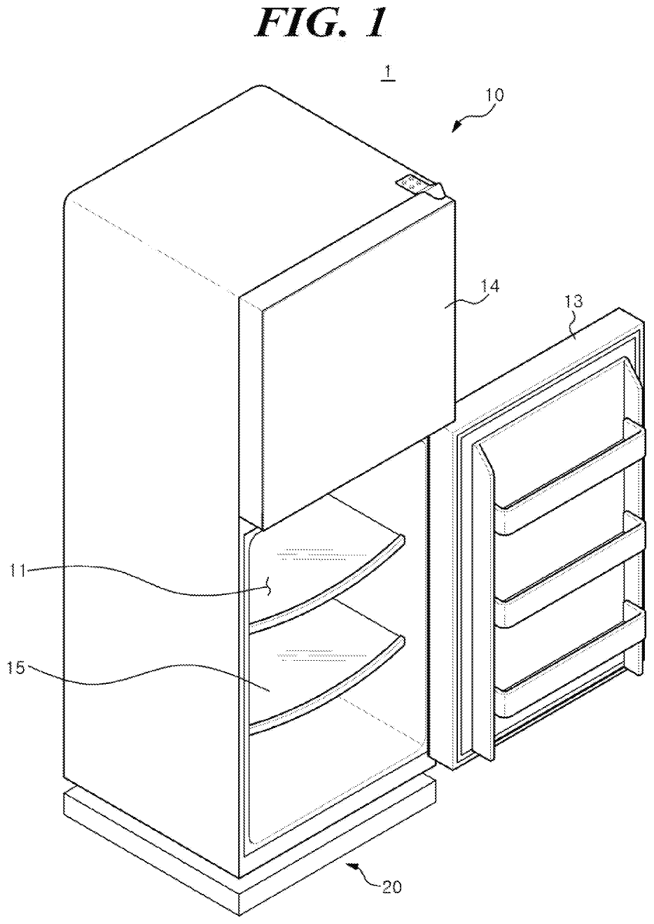

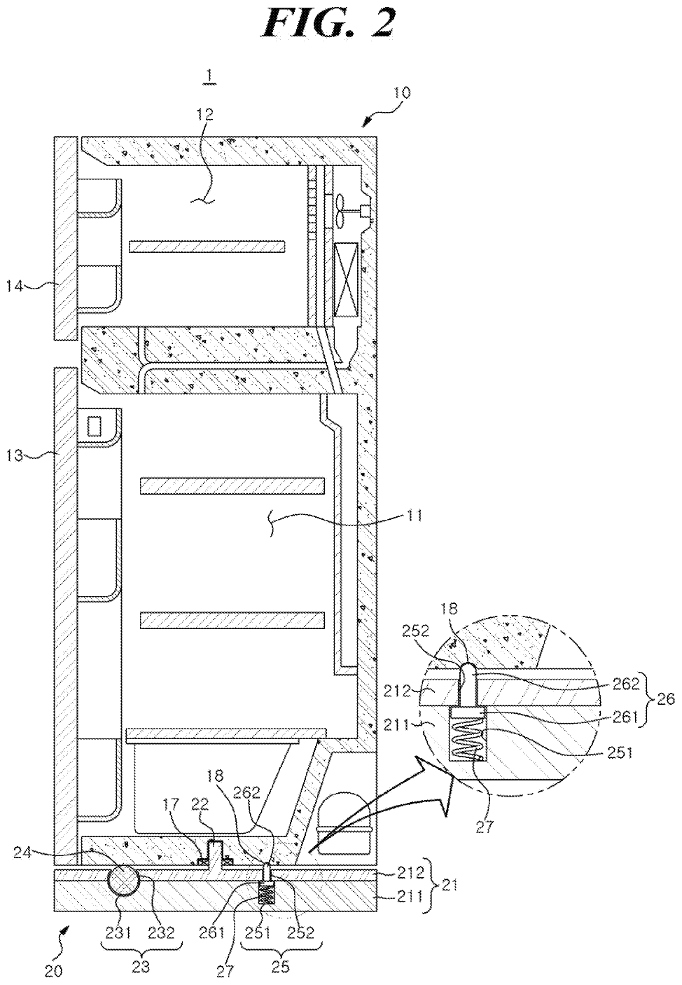

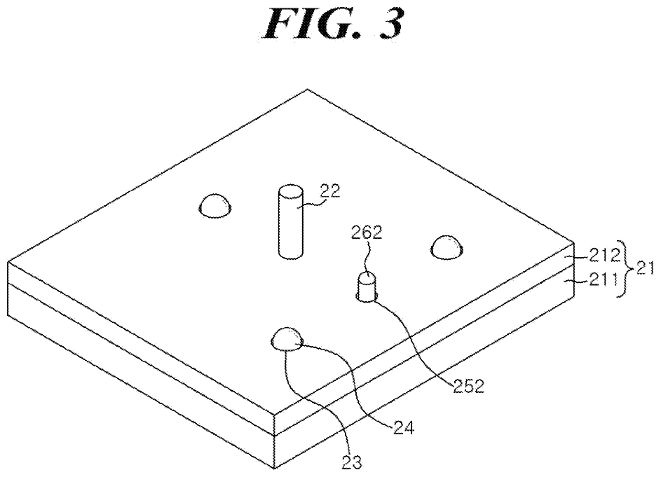

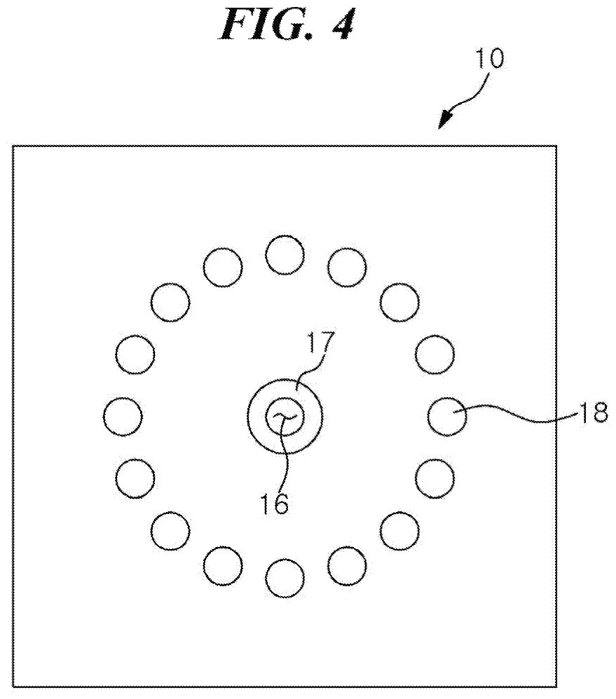

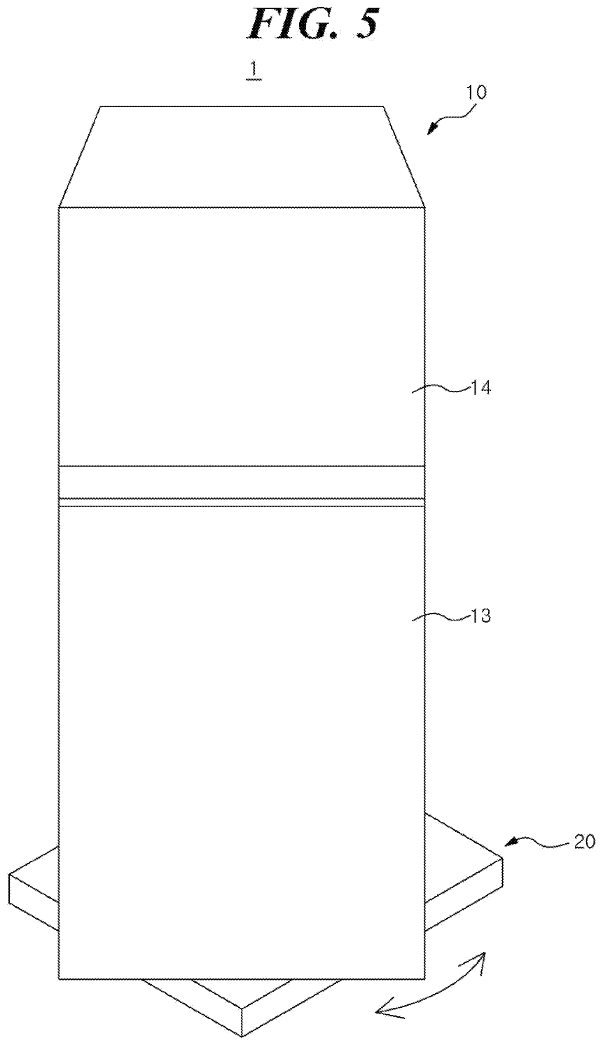

FIG. 1 is a perspective view showing a configuration of a refrigerator according to one or more embodiments of the disclosure, FIG. 2 is a cross-sectional view schematically showing an embodiment of the refrigerator of FIG. 1, FIG. 3 is a perspective view showing a support device suitable for the refrigerator of FIG. 1, FIG. 4 is a bottom view of the main body of the refrigerator of FIG. 1, and FIG. 5 is a perspective view showing a state in which an angle between the main body and the support device of the refrigerator of FIG. 1 is changed. Specifically, FIGS. 1 to 4 show a top-mount type refrigerator.

Referring to FIGS. 1 to 5, the refrigerator 1 is for storing the food in a low temperature state and may include a main body 10 having one or more food storage spaces 11 and 12 and a support device configured to rotatably support the main body 20.

The main body 10 may include one or more doors 13 and 14 configured to open and close at least one of the storage spaces 11 and 12. As an example, the main body 10 may have a refrigerating chamber 11 and a freezing chamber 12 as storage spaces. In this case, a front face of the main body 10 may include a refrigerating chamber door 13 for selectively shielding the refrigerating chamber 11 and a freezing chamber door 14 for selectively shielding the freezing chamber 12.

Further, in the main body 10, the freezing chamber 12 may be above the refrigerating chamber 11, and the cool air generated by an evaporator in the rear direction of an inner case in or behind the main body 10 may be discharged from the rear face of the freezing chamber 12.

The refrigerator 1 may include a cool air supply device configured to supply cool air through a cooling cycle and/or to maintain the storage space at a predetermined temperature. Such a cool air supply device may include a compressor, an expansion valve, an evaporator, a condenser and the like.

The main body 10 may rotate above or on the upper portion or surface of the support device 20. A lower surface of the outside of the main body 10 may include a coupling hole, cavity or opening 16, a bearing 17 and a plurality of latching holes, cavities or openings 18. Specifically, the coupling hole, cavity or opening 16 may be on or in a lower surface in the center of the main body 10, and a bearing 17 may be outside and/or surrounding the coupling hole, cavity or opening 16. A plurality of latching holes, cavities or openings 18 may be at predetermined intervals with respect to each other and to the coupling hole, cavity or opening 16. In the embodiment shown in FIG. 4, sixteen latching holes, cavities or openings 18 at intervals of 22.5° are shown. However, the number and interval of the latching holes, cavities or openings 18 are not limited thereto. As an example, twenty or more latching holes, cavities or openings 18 may be present to increase the number of rotational positions of the main body 10. Alternatively, less than 16 latching grooves holes, cavities or openings 18 may be present (e.g., 12 latching holes, cavities or openings 18, spaced apart from each other at intervals of 30°, may be present). Specific details of the coupling hole, cavity or opening 16, the bearing 17 and the latching holes, cavities or openings 18 will be described later.

A support device 20 may be below the main body 10. The support device 20 may be on the bottom surface of an installation space of the refrigerator, and may fix the main body 10 to a point or location (e.g., in a room, such as a kitchen).

The support device 20 may have a predetermined thickness and may have an area corresponding to the size (e.g., horizontal area) of the main body 10. In the embodiment shown in FIG. 1, the support device 20 has a rectangular cross-sectional shape, as an example. However, the shape of the support device 20 is not limited thereto. For example, the support device 20 may have a circular, oval or square cross section.

The support device 20 may include a support body 21, which may have a plate shape. Specifically, the support body 21 may include a first body 211 configured to contact the ground, and a second body 212 on the first body 211.

A rotatable shaft 22 may be on and/or in the upper surface in the center of the support body 21. Although the rotatable shaft 22 is shown extending from the second body 212 in the embodiment of FIGS. 2-3, the rotatable shaft 22 may extend from the first body 211 and may penetrate through the second body 212. The rotatable shaft 22 is inserted into the coupling hole, cavity or opening 16 of the main body 10 and may protrude upward. Specifically, the coupling hole, cavity or opening 16 may have a size corresponding to the diameter and/or height of the rotatable shaft 22. Accordingly, the main body 10 may rotate in the horizontal direction (e.g., clockwise and/or counterclockwise) with respect to the rotatable shaft 22.

In this case, the bearing 17 may be coupled with or to the rotatable shaft 22 to support the load (e.g., the main body 10 or the refrigerator 1). The bearing 17 may be configured so that the end of the rotatable shaft 22 does not contact the deepest surface of the coupling hole, cavity or opening 16. That is, the end of the rotatable shaft 22 may be separated or isolated from the inner surface of the coupling hole, cavity or opening 16 so that the main body 10 may smoothly rotate without friction or with minimal friction.

A plurality of ball cavities or sockets 23 may be on one side of the support body 21. Further, the ball cavities or sockets 23 may include or house a ball 24 configured to rotatably support the main body 10. Specifically, the ball cavities or sockets 23 may have a size corresponding to the ball 24, and may be spaced by a predetermined interval from the rotatable shaft 22.

The ball cavities or sockets 23 may comprise separate cavities or sockets in the first body 211 and the second body 212, coupled to and/or overlapping with each other. Specifically, in one example, a cavity or socket 231 having a depth of about half the diameter of the ball 24 may be on or in the upper surface of the first body 211, and an overlapping cavity or hole 232 that encloses a portion (e.g., a spherical segment) of the ball 24 may be in the second body 212. That is, the cavity or socket 231 in the first body 211 may have a hemisphere shape corresponding to the size of the ball 24, and the cavity or hole 232 in the second body 212 may expose a part (e.g., an upper surface) of the ball 24 and may cover most of the upper half of the ball 24. Further, the ball 24 may be rotatably placed or positioned in the ball cavity or socket 23 (e.g., in the space in or between the first body 211 and the second body 212 provided by the cavity or socket 231 and the cavity or hole 232).

In this case, the cavity or socket 231 in the first body 211 may have a diameter at its uppermost point or height that corresponds to (e.g., is slightly larger than) the diameter of the ball 24, and the horizontal cross-section of the cavity or socket 231 becomes narrower along its depth. Further, the cavity or hole 232 in the second body 212 may have a shape in which the opening in the upper surface of the second body 212 may be smaller than the diameter of the ball 24, and the horizontal cross-section of the cavity or hole 232 may gradually increase toward the lowermost surface of the second body 212 so as to correspond to the diameter of the ball 24. In this case, a part of the ball 24 may be exposed through the opening in the upper surface of the second body 212.

Thus, after the ball 24 is placed in the cavity or socket 231 in the first body 211, since the second body 212 is positioned on the first body 211, the ball 24 may be in the cavity or socket 23. Further, since part of the ball 24 is exposed through the second body 212, a portion of the upper side (e.g., an uppermost surface) of the ball 24 may contact the lowermost portion or surface of the main body 10. That is, the main body 10 may be easily moved using the balls 24 (see, e.g., FIG. 3). In the embodiment shown in FIG. 3, three ball cavities or sockets 23 and three balls 24 are present as an example. However, the number of ball cavities or sockets 23 and balls 24 is not limited thereto. For example, four (or any other integer number of three or more) ball cavities or sockets 23 and balls 24 may be present in one support device 20.

A mounting hole, cavity or opening 25 may be on and/or in one side of the support body (21). Further, the mounting hole, cavity or opening 25 may include a coupling pin 26 and an elastic member 27. In this case, the mounting hole, cavity or opening 25 may be at a position that does not overlap the rotatable shaft 22 and/or the ball cavities or sockets 23. For example, the mounting hole, cavity or opening 25 may be spaced by a predetermined interval from the rotatable shaft 22 and the two nearest ball cavities or sockets 23. Further, the mounting hole, cavity or opening 25 may include a first mounting hole, cavity or opening 251 in the first body 211 and a second mounting hole, cavity or opening 252 in the second body 211.

The coupling pin 26 is configured to fix or set the main body 10 at a predetermined position and may include a head 261 and an extension 262 extending upward from the head 261. In this case, the head 261 may have a larger diameter than the extension 262. Further, the upper surface or tip of the extension 262 may be rounded.

Although one coupling pin 26 and mounting hole, cavity or opening 25 are shown in the embodiment of FIG. 3 as an example, the support device 20 may comprise a plurality of coupling pins 26 and mounting holes, cavities or openings 25. In the latter case, the direction in which the front face of the main body 10 is oriented may be more firmly fixed.

The first mounting hole, cavity or opening 251 may have a size corresponding to the head 261, and the second mounting hole, cavity or opening 252 may have a size corresponding to the extension 262. Thus, when the second body 212 is on the first body 211 and the coupling pin 26 is on or in the first body 211, the head 261 may be prevented from being released outside the support body 21 due to the second body 212 (e.g., having a hole or opening 252 with area dimensions smaller than those of the head 261). In this case, the head 261 may be supported by the elastic member 27. That is, the elastic member 27 may be in the first mounting hole, cavity or opening 251.

When the coupling pin 26 is on or in the support body 21, the upper portion or tip of the extension 262 may be exposed through the second body 212. In this case, the upper portion or tip of the extension 262 may be forced into any one of the latching holes, cavities or openings 18 of the main body 10.

Specifically, the latching holes, cavities or openings 18 may be in the outside lower surface of the main body 10 at predetermined intervals, and the latching holes, cavities or openings 18 may have a size corresponding to the rounded upper surface or tip of the extension 262.

When the main body 10 rotates in one or the other direction (e.g., clockwise or counterclockwise) by the user, the extension 262 of the coupling pin 26 may be released from the latching hole, cavity or opening 18. In this case, the rounded end or tip of the extension 262 and the inside surface of the latching holes, cavities or openings 18 may have shapes corresponding to each other and act like a cam. That is, the end or tip of the extension 262 slides along an inside surface of the latching hole, cavity or opening 18 by force from the user rotating the main body 10 so that the coupling pin may come out of the latching hole, cavity or opening 18. To this end, the latching holes, cavities or openings 18 may have a rounded periphery or outer edge.

The coupling pin 26 may be movable up and down due to the elastic member 27. When the user rotates the main body 10 to a desired angle, the elastic member 27 may be tensioned and may fit into one of the latching holes, cavities or openings 18 at another position. That is, the main body 10 may be fixed.

In the embodiment shown in FIG. 2, the elastic member 27 is or comprises a spring as an example, but the elastic member 27 is not limited thereto. In an example, the elastic member 27 may be or comprise a leaf spring.

Hereinafter, the operation and effect of the refrigerator 1 having the above-described configuration(s) will be described.

The installation position of the main body 10 of the refrigerator 1 may be determined by the support device 20. Specifically, when the support device 20 is installed at one point or in one location, the main body 10 may be coupled and/or fixed to the support device 20.

The main body 10 may be rotatable with respect to the shaft 22 of the support device 20. In this case, a bearing 22 may be on the outside or peripheral surface of the rotatable shaft 22, so that the rotation of the main body 10 may be facilitated.

Further, one or more balls 24 may be on one side (e.g., on or exposed through an uppermost surface) of the support device 20. The ball(s) 24 may be in one or more ball cavities or sockets 23, and one part (e.g., the uppermost portion) of the ball 24 may contact the lower surface of the main body 10. That is, since the ball 24 is provided the main body 10 and the support body 21, rotation of the main body 10 may be facilitated.

When the user rotates the main body 10 to one side or in one direction, the extension 262 of the coupling pin 26 may be released from the latching hole, cavity or opening 18 in the main body 10. In this case, as the main body 10 rotates, the elastic member 27 supporting the coupling pin 26 may be compressed, and the coupling pin 26 may move to a position corresponding to another one of the plurality of latching holes, cavities or openings 18. Further, as the elastic member 27 is tensioned, the coupling pin 26 may fit in or enter one of the latching holes, cavities or openings 18 (e.g., as the main body moves to a position in which a latching hole, cavity or opening 18 overlaps the coupling pin 26). That is, the position of the main body 10 may be fixed.

As the main body 10 is rotatable on the support device 20, the position of the front face of the main body 10 may be changed. Accordingly, the user may direct the front face of the main body 10 in a desired direction, and the door(s) 13 and 14 may be opened and closed in a desired position, so that food or other products in the storage space may be easily withdrawn.

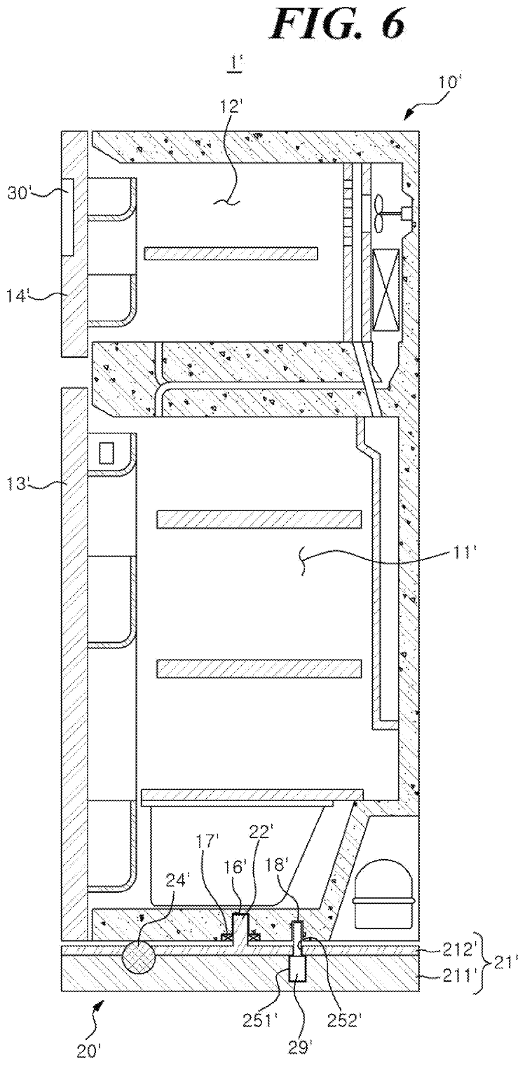

Hereinafter, a refrigerator according to another embodiment of the disclosure will be described with reference to FIG. 6. However, in the embodiment(s) of FIG. 6, there are differences from other embodiments (e.g., that of FIG. 2) in that a fixing member 29′ and a control unit 30′ are included in the embodiment(s) of FIG. 6. Thus, the differences between the embodiment(s) of FIG. 6 and the embodiment(s) of FIG. 2 will be mainly described, and the same components and/or features will use the descriptions and the same reference numbers as the embodiment(s) of FIGS. 2-5.

FIG. 6 is a cross-sectional view schematically showing a configuration of a refrigerator according to another embodiment of the disclosure.

Referring to FIG. 6, a refrigerator 1′ may include a fixing member 29′ and a control unit 30′.

The fixing member 29′ moves up and down in accordance with a control signal from the control unit 30′ and may be contained in the mounting hole, cavity or opening 25′ in the support body 21′. Further, a part of the fixing member 29′ may be outside the body 21′, and may be coupled to the latching hole, cavity or opening 18′ in the main body 10′. In this case, the fixing member 29′ is a drive device configured to selectively project a pin 252′ to latch the pin 252′ in the latching holes, cavities or openings 18′ in response to the signal from the control unit 30′. The fixing member 29′ may be or comprise a solenoid device, for example. However, the type of the fixing member 29′ is not limited thereto. For example, the fixing member 29′ may be or comprise a pneumatic cylinder.

In order for the user to rotate the main body 10, the control unit 30′ may be controlled or manipulated by the user. The control unit 30′ may be on one side of the main body 10 (e.g., behind an outer surface of one of the doors 13′ and 14′; a user interface such as a touch panel, a button or a switch may be on the surface of the door 13′ or 14′, and the control unit 30′ may control the fixing member 29′ in response to a setting or command from the user interface).

When a signal to rotate the main body 10 is input by the user, the control unit 30′ may withdraw the fixing member 29′ (specifically, the extension 252′) from the latching hole, cavity or opening 18′. That is, the fixing member 29′ may be released from the latching hole, cavity or opening 18′ in the main body 10′ in response to a command or signal from the control unit 30′.

When the fixing member 29′ is released from the main body 10′, the user may control the control unit 30′ again after rotating the main body 10 to a desired angle. That is, the control unit 30′ may be instructed to insert the fixing member 29′ into one of the plurality of latching holes, cavities or openings 18′ (e.g., at the desired angle).

The foregoing detailed description illustrates the disclosure as one or more examples. Further, the foregoing is intended to illustrate and explain embodiments of the disclosure and the disclosure may be utilized in various other combinations, modifications and environments. That is, it is possible to be changed or modified within the scope of the concept of the disclosure in this specification, the scope of disclosure and the equivalent scope and/or the skill or knowledge of the disclosure. The embodiments described are intended to illustrate the best mode for carrying out the technical idea of the disclosure, and various modifications may be made to the specific applications and uses of the disclosure. Therefore, the detailed description is not intended to limit the disclosure to the disclosed embodiments. Further, the appended claims should be construed to include other embodiments.

What is claimed is:

1. A refrigerator comprising:
a main body having one or more storage spaces; and
a support device configured to rotatably support the main body, wherein the main body includes:
one or more storage spaces,
a front face; and
one or more doors configured to open and close at least one of the one or more storage spaces,
the support device includes:
a support body;
a rotatable, upwardly extending shaft at or in a center of the support body and in a coupling hole, cavity or opening in the main body;
a plurality of balls on and/or in the support body, configured to support the main body; and
a coupling pin configured to move in a vertical direction and to fix a direction of the front face of the main body, and
the main body includes a plurality of latching holes, cavities or openings outside the coupling hole, cavity or opening, configured to receive the coupling pin, such that the coupling pin limits rotation of the main body when the coupling pin is in one of the plurality of the latching holes, cavities or openings.

2. The refrigerator according to claim 1, wherein the support device includes a mounting hole, cavity or opening containing the coupling pin, and

3. The refrigerator according to claim 2, wherein the mounting hole, cavity or opening includes an elastic member configured to elastically support the coupling pin and enable the coupling pin to move in a vertical direction.

4. The refrigerator according to claim 2, wherein the coupling pin includes a head supported by the elastic member and configured to move from and/or in the mounting hole, cavity or opening in the vertical direction; and
an extension extending upward from the head and having a diameter smaller than that of the head and a rounded upper surface or tip.,

5. The refrigerator according to claim 4, wherein the latching holes, cavities or openings have a shape corresponding or complementary to the upper surface or tip of the extension.

6. The refrigerator according to claim 4, wherein the upper surface or tip of the extension is configured to slide along a surface of the latching holes, cavities or openings. The refrigerator according to claim 3, wherein the support body includes a first body having a first hole, cavity or opening with a size corresponding to the head; and
a second body having a second hole, cavity or opening with a size corresponding to the extension.

8. The refrigerator according to claim 7, wherein the ball is in or between the first body and the second body, and a part or portion of the ball is exposed by the second body and is configured to touch or contact the main body.

9. The refrigerator according to claim 7, wherein the first body includes a spherical cavity or socket,
the ball is in the spherical cavity or socket,
the second body has a third hole configured to expose a part or surface of the ball and/or to cover part of the ball, and
the ball is configured to roll or rotate in a space in the first body and the second body.

10. The refrigerator according to claim 4, wherein the head and the elastic member are in the first hole, cavity or opening in the first body, and the extension penetrates the second hole, cavity or opening in the second body.

11. The refrigerator according to claim 10, wherein the head is prevented from leaving the first body.

12. The refrigerator according to claim 1, comprising a plurality of the coupling pins and mounting holes, cavities or openings.

13. The refrigerator according to claim 1, wherein the rotatable shaft is coupled to a bearing in the coupling hole, cavity or opening, and an end of the rotatable shaft is spaced apart from a deepest surface of the coupling hole, cavity or opening.

14. The refrigerator according to claim 1, wherein the support body has a plate shape or a substantially flat or planar uppermost surface.

15. A support device configured to support a main body of a refrigerator having a front face, comprising:
a support body having an upper surface;
a rotatable shaft on or in a center of the upper surface of the body;
a ball on or in the support body, a surface of which is configured to touch or contact the main body; and
a coupling pin configured to be selectively coupled to the main body,
wherein the support body includes a plurality of ball cavities or sockets spaced apart from the rotatable shaft by a predetermined interval, and a mounting hole, cavity or opening that includes the coupling pin at a position not overlapping the rotatable shaft and the ball cavities or sockets, and
the coupling pin is configured to move up and down in the mounting hole, cavity or opening, and as the main body rotates, the coupling pin is configured to catch in one of a plurality of latching holes, cavities or openings on or in a bottom surface of the main body.

16. The support device according to claim 15, wherein
the support body includes:
a first body configured to contact a floor or other ground surface; and
a second body on the first body,
the coupling pin includes:
an extension having a rounded shape or end, configured to enter the latching holes, cavities or openings; and
a head on one side of the extension and in the first body or between the first body and the second body.

17. The support device according to claim 15, wherein the head is in the mounting hole, cavity or opening, the support body further comprises an elastic member in the mounting hole, cavity or opening that elastically supports the head.

18. The support device according to claim 16, wherein
when the main body rotates, the elastic member is compressed, and the coupling pin moves into the mounting groove hole, cavity or opening, and
when the coupling pin overlaps one of the latching holes, cavities or openings, the coupling pin moves into the one latching hole, cavity or opening.

19. A refrigerator comprising:
a main body having one or more storage spaces; and
a support device configured to rotatably support the main body,
wherein the main body includes:
one or more storage spaces having an open front face;
one or more doors configured to open and close at least one of the one or more storage spaces, and
a control unit configured to control the support device,
the support device includes:
a support body;
a rotatable, upwardly extending shaft at or in a center of the support body, in a lower part or portion of the main body;
a plurality of balls on or in the support body configured to support the main body and/or enable the main body to rotate about the rotatable shaft; and
a fixing member capable of moving up and down in accordance with a signal from the control unit;
the main body includes a plurality of latching holes, cavities or openings corresponding to the fixing member in the lower part or portion thereof and a coupling hole, cavity or opening configured to receive the rotatable shaft, and
the fixing member moves up and down according to the signal from the control unit, to be respectively coupled to or released from one of the latching holes, cavities or openings.
